(19) United States
(12) Patent Application Publication
(10) Pub. No.: US 2013/0185257 A1
(43) Pub. Date: Jul. 18, 2013

(54) CLOUD DATA RESILIENCY SYSTEM AND METHOD

(71) Applicants: Krishna P. Puttaswamy Naga, Metuchen, NJ (US); Thyagarajan Nandagopal, Edison, NJ (US); Yadi Ma, Madison, WI (US)

(72) Inventors: Krishna P. Puttaswamy Naga, Metuchen, NJ (US); Thyagarajan Nandagopal, Edison, NJ (US); Yadi Ma, Madison, WI (US)

(21) Appl. No.: 13/348,908

(22) Filed: Jan. 12, 2012

(51) Int. Cl. G06F 17/30

(52) U.S. Cl. 707/634; 707/E17.005

(57) ABSTRACT

An exemplary cloud data system includes a primary datacenter device that maintains a complete copy of a file. A plurality of secondary datacenter devices maintain respective encoded, partial copies of the file. At least some of the encoded partial copies are sufficient to recreate the complete copy of the file. The primary datacenter device makes any changes to the complete copy of the file responsive to any write operation on the file. The primary datacenter device provides correspondingly changed encoded partial copies to the respective secondary datacenter devices.

### BACKGROUND

Cloud service providers (CSPs) operate cloud computing infrastructure using multiple datacenters. Failures at datacenters are fairly common. This can be problematic when a user is attempting to access a file for a read or write operation. CSPs attempt to avoid the problems associated with a datacenter failure by replicating files and storing them at multiple datacenters. With increasing numbers of users and enterprises moving to cloud systems, the costs associated with replicating and keeping the data consistent across multiple locations increases.

As cloud use increases, there are associated increasing storage and bandwidth costs as larger amounts of data have to be replicated and transferred between datacenters. Additionally, maintaining consistency becomes increasingly complex as the likelihood of multiple users making different changes to distinct copies of data increases.

### SUMMARY

An exemplary cloud data system includes a primary datacenter device that maintains a complete copy of a file. A plurality of secondary datacenter devices each maintain a respective encoded, partial copy of the file. At least some of the encoded partial copies are sufficient to recreate the complete copy of the file. The primary datacenter device makes any changes to the complete copy of the file responsive to any write operation on the file. The primary datacenter device provides correspondingly changed encoded partial copies to the respective secondary datacenter devices.

An exemplary method of managing data in a cloud data system includes maintaining a complete copy of a file at a primary datacenter device and maintaining an encoded partial copy of the file at each of a plurality of secondary datacenter devices. At least some of the encoded partial copies are sufficient to recreate the complete copy of the file. Any changes to the complete copy of the file are made at the primary datacenter device responsive to any write operation on the file. The primary datacenter device provides correspondingly changed encoded partial copies to the respective secondary datacenter devices.

The various features and advantages of a disclosed example embodiment will become apparent to those skilled in the art from the following detailed description. The drawings that accompany the detailed description can be briefly described as follows.

### BRIEF DESCRIPTION OF THE DRAWINGS

FIG. 1 schematically illustrates an example system that is configured according to an embodiment of this invention.

FIG. 2 is a flowchart diagram that summarizes an example cloud data management feature of an example embodiment.

### DETAILED DESCRIPTION

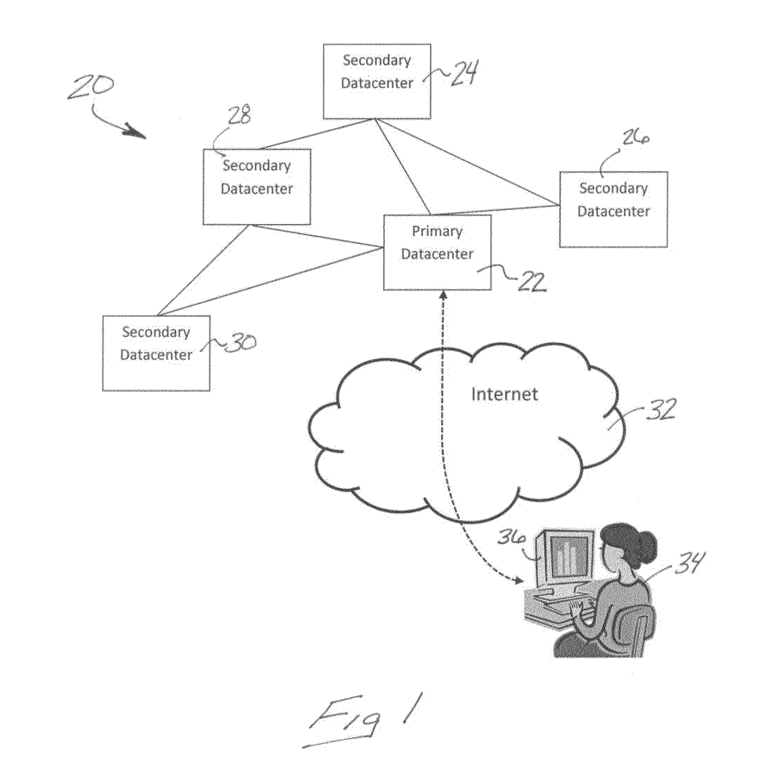

FIG. 1 schematically illustrates a cloud computing system 20 that includes a plurality of datacenter devices 22, 24, 26, 28 and 30. Each of the datacenter devices comprises one or more computing components, such as a computer, processor or memory. The illustrated datacenter devices may be located in diverse geographical locations.

The datacenter devices maintain any number of files or data records. For each file or data record, one of the datacenter devices will serve as a primary datacenter and the others will serve as secondary datacenters. It is possible for any of the datacenter devices 22-30 to serve as the primary datacenter device for any particular data record or file and to serve as a secondary datacenter device for any other data record or file. For discussion purposes, one example file will be considered. The datacenter device 22 is the primary datacenter device that maintains a complete copy of the file. Each of the datacenter devices 24-30 is a secondary datacenter device that does not maintain a complete copy of the file. Instead the secondary datacenter devices 24-30 each maintain an encoded partial copy of the file.

The primary datacenter device 22 is configured to divide the contents of the file into various portions and to generate or establish an encoded partial copy corresponding to each portion. The primary datacenter device 22 provides each encoded partial copy to at least one of the secondary datacenter devices 24-30. The primary datacenter device 22 keeps records of which secondary datacenter devices maintains each of the partial copies.

In one example, each partial copy pertains to a different portion or segment of the complete file and each of the secondary datacenter devices 24-30 maintains a different partial copy compared to the partial copy maintained at the other secondary datacenter devices. In another example, one or more partial copies may be replicated and maintained at more than one datacenter device. At least one of the secondary datacenter devices 24-30 maintains a partial copy that is different than the partial copy maintained by at least one other of the secondary datacenter devices.

Maintaining a single complete copy of the file at the primary datacenter device 22 and the encoded partial copies at the secondary datacenter devices 24-30, respectively, provides efficiencies in utilizing storage and bandwidth while providing resiliency to ensure that the file is available when needed.

The cloud computing system 20 is accessible over the Internet 32 by a user 34 using a suitable device 36 such as a computer. The user 34 may access the file maintained by the cloud computing system 20 for read or write operations. In the illustrated example, any write operations are carried out on the complete copy of the file maintained at the primary datacenter 22. Even if the user 34 is closer to one of the secondary datacenter devices, the user access is routed to the primary datacenter 22 from which the complete copy of the file is accessible.

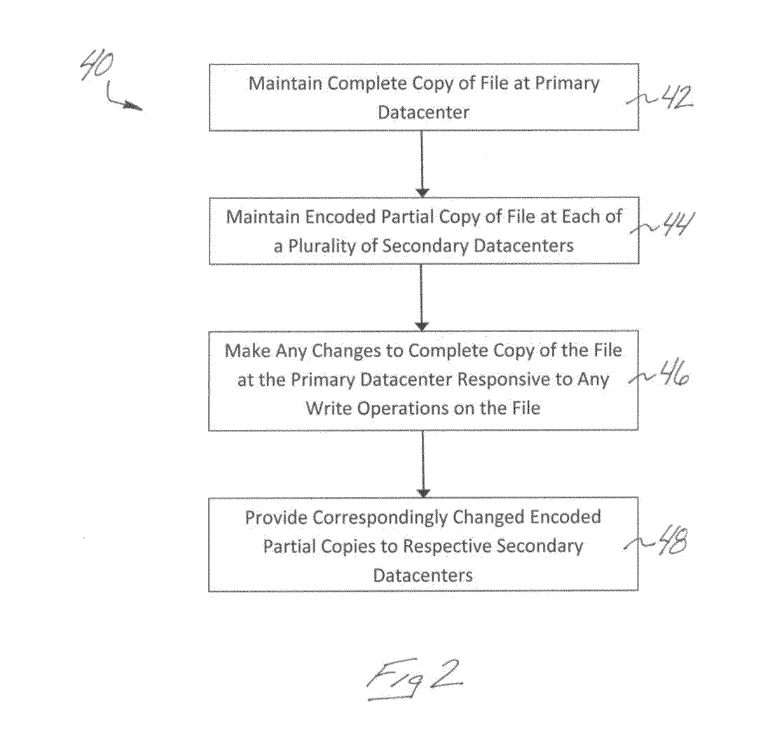

An example method is summarized in the flowchart diagram 40 of FIG. 2. At 42, the primary datacenter device 22 maintains the complete copy of the file. At 44 the secondary datacenter devices each maintain an encoded partial copy of the file. The primary datacenter device 22 changes the complete file at 46 with changes that correspond to changes made through a write operation requested by the user 34. The primary datacenter establishes or generates correspondingly changed encoded partial copies of the file and provides those to the appropriate secondary datacenter devices at 48.

The primary datacenter device 22 is configured to perform a plurality of write operations on the file (i.e., changes to the data in the file) during a single session that has a beginning and an end. In the illustrated example, read operations on a file are always served from the primary file at the primary datacenter device to provide strong consistency guarantees. Whenever the primary datacenter device 22 receives a write, it makes a copy of the file and the older copy is served for new read requests while the new copy is used to perform writes. The older and new copies are merged when the write is finished (via a close call).

In one example, the primary datacenter device 22 dynamically provides updated partial copies to the appropriate secondary datacenter devices at various times during the session before the session ends. In another example, the primary datacenter closes the session before providing correspondingly changed partial copies to the appropriate secondary datacenter devices. By only requiring changes to partial copies that are affected by any changes to the complete file, the illustrated example provides additional flexibility in communicating changes to the file to the various secondary datacenter devices.

The complete copy of the file at the primary datacenter device is used for all read and write operations involving the file and the encoded partial copies provide resiliency. Making all changes to the file by making them exclusively to the complete copy and then distributing correspondingly updated partial copies to the secondary datacenter devices ensures consistency of the file contents in the event that more than one user is making changes to the file data at approximately the same time. This approach also allows for efficiently using memory at the secondary devices and conserving bandwidth for communicating file content updates among the datacenter devices.

The illustrated example reduces replication overhead. A coding scheme, such as the known (m+k, m) erasure code, is used in one example to divide up the complete file into multiple portions. With such a coding scheme m+k portions are stored and only m of them are needed to reconstruct the entire file. In other words, such a coding scheme provides resiliency to ensure data availability even if there are up to k failures in the cloud system 20 that hinder access to file contents. Another example uses the known Reed-Solomon code for establishing the encoded partial copies of the file. Those skilled in the art that have the benefit of this description will be able to select a coding scheme that meets their particular needs.

The code scheme in the illustrated example provides exact repair of systematic parts. This allows for an erased portion to be reconstructed at another place so that it is the same as before.

If there is a transient failure of any of the backup partial copies, for example, no action is required and no decoding is needed to honor a read request. This is different than the case if an “All Code” replication strategy were used. An All Code scheme divides a file using a (m+k, m) erasure code and the various chunks are stored in different datacenters. If there is a permanent failure of any file chunk in an All Code case, the whole file needs to be reconstructed by contacting all the other datacenters so that a new chunk can be generated to replace the failed one. By contrast, if the primary datacenter device 22 determines that any of the partial copies is unreliable or unavailable, the primary datacenter device 22 establishes or generates another copy of that partial copy and provides that to one of the secondary datacenter devices. The primary datacenter device can readily determine the contents of the encoded partial copy to replace the one that is no longer available or unreliable based on the contents of the complete copy of the file and information available to the primary datacenter device regarding how the complete file is divided into the portions.

In the event that the primary datacenter device 22 fails to provide desired access or the complete copy of the file becomes unreliable, one of the secondary datacenter devices determines this and at least temporarily becomes the primary datacenter and recreates the complete data file from its partial copy and the m-1 other partial copies from the other secondary datacenter devices.

The example system and method includes several features that are superior to other possible approaches at managing data resiliency in a cloud system. Storing only the partial copies at the secondary datacenter devices instead of storing multiple complete copies of the file provides significant savings in initial storage and bandwidth costs associated with data transfer between the datacenters. There are also significant savings in bandwidth costs during file updates associated with write operations. The updates need only be made to the affected partial copies instead of making k copies of the entire file and communicating that to each of the backup datacenters. Bandwidth costs during recovery operations are also significantly reduced. A permanent failure of any partial copy can easily be replaced by the primary datacenter device by generating a replacement of the filed partial copy and providing that to a new secondary datacenter. By contrast, an All Replica scheme, which stores k+1 full copies of a file to provide k redundancy, requires replacing the whole data item or file and that has a much higher data transfer cost.

Additionally, using a pre-determined primary datacenter for each file avoids the complications associated with “All Code” replication schemes. In All Code schemes any node serving a write request handles subsequent writes before a session closes, which leads to potential consistency problems, when multiple users attempt to write to the file from diverse locations.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A cloud data system, comprising:
a primary datacenter device that maintains a complete copy of a file;
a plurality of secondary datacenter devices that each maintain a respective encoded, partial copy of the file, wherein at least some of the encoded partial copies are sufficient to recreate the complete copy of the file;
the primary datacenter device making any changes to the complete copy of the file responsive to any write operation on the file, the primary datacenter device providing correspondingly changed encoded partial copies to the respective secondary datacenter devices.

2. The system of claim 1, wherein
there is a set of existing encoded partial copies;
the primary datacenter device determines which ones of the existing encoded partial copies are affected by any change to the complete copy of the file;
the primary datacenter device establishes a correspondingly changed encoded partial copy for each of the affected ones; and
the first data center device provides the correspondingly changed encoded partial copy of each of the affected ones to the respective secondary datacenter devices.

3. The system of claim 1, wherein
the primary datacenter device makes a plurality of changes to the complete copy of the file during a session that has a beginning and an end; and
the primary datacenter device provides correspondingly changed encoded partial copies to the respective secondary datacenter devices responsive to each of the changes prior to the end of the session.

4. The system of claim 1, wherein
the primary datacenter device makes a plurality of changes to the complete copy of the file during a session that has a beginning and an end; and
the primary datacenter device provides the correspondingly changed encoded partial copies to the respective secondary datacenter devices responsive to each of the changes after the close call.

5. The system of claim 1, wherein each of the secondary datacenter devices maintains an encoded partial copy of the file that is different than the encoded partial copy of the file maintained by at least one different secondary datacenter device.

6. The system of claim 1, wherein each of the secondary datacenter devices maintains an encoded partial copy of the file that is different than the encoded partial copy of the file maintained by each of the rest of the secondary datacenter devices.

7. The system of claim 1, wherein one of the encoded partial copies is determined to be unreliable or unavailable;
the primary datacenter device generates a replacement encoded partial copy of the one of the encoded partial copies; and
the primary datacenter device provides the replacement encoded partial copy to one of the secondary datacenter devices.

8. The system of claim 1, wherein at least one of the secondary datacenter devices determines when the primary datacenter fails;
the at least one of the secondary datacenter devices replaces the failed primary datacenter device as a new primary datacenter device; and
the new primary datacenter device regenerates the file from the encoded partial copies.

9. The system of claim 1, wherein the primary datacenter makes a new copy of the complete file responsive to a write operation;
uses the complete file to serve any subsequent read requests before the write operation is finished; and
merges the new copy and the complete file when the write operation is finished.

10. A method of managing data in a cloud data system, comprising the steps of:
maintaining a complete copy of a file at a primary datacenter device;
maintaining an encoded partial copy of the file at each of a plurality of secondary datacenter devices, wherein at least some of the encoded partial copies are sufficient to recreate the complete copy of the file;
making any changes to the complete copy of the file at the primary datacenter device responsive to any write operation on the file; and
providing correspondingly changed encoded partial copies from the primary datacenter device to the respective secondary datacenter devices.

11. The method of claim 10, wherein there is a set of existing encoded partial copies and the method comprises:
determining which ones of the existing encoded partial copies are affected by any change to the complete copy of the file;
establishing a correspondingly changed encoded partial copy for each of the affected ones; and
providing the correspondingly changed encoded partial copy of each of the affected ones from the primary datacenter device to the respective secondary datacenter devices.

12. The method of claim 10, comprising:
making a plurality of changes to the complete copy of the file during a session that has a beginning and an end; and
providing correspondingly changed encoded partial copies to the respective secondary datacenter devices responsive to each of the changes prior to the end of the session.

13. The method of claim 10, comprising:
making a plurality of changes to the complete copy of the file during a session that has a beginning and an end; and
providing the correspondingly changed encoded partial copies to the respective secondary datacenter devices responsive to each of the changes after the end of the session.

14. The method of claim 10, comprising
maintaining an encoded partial copy of the file at each of the secondary datacenter devices that is different than the encoded partial copy of the file maintained by at least one different secondary datacenter device.

15. The method of claim 10, comprising
maintaining an encoded partial copy of the file at each of the secondary datacenter devices that is different than the encoded partial copy of the file maintained by each of the rest of the secondary datacenter devices.

16. The method of claim 10, comprising
determining that one of the encoded partial copies is unreliable or unavailable;
generating a replacement encoded partial copy of the one of the encoded partial copies at the primary datacenter device; and
providing the replacement encoded partial from the primary datacenter device to one of the secondary datacenter devices.

17. The method of claim 10, comprising
determining when the primary datacenter fails;
replacing the failed primary datacenter device with one of the secondary datacenter devices as a new primary datacenter device; and
regenerating the file from the encoded partial copies at the new primary datacenter device.

18. The method of claim 10, comprising
making a new copy of the complete file at the primary datacenter responsive to a write operation;
using the complete file to serve any subsequent read requests before the write operation is finished; and
merging the new copy and the complete file at the primary datacenter when the write operation is finished.
